(19) United States
(12) Patent Application Publication
(10) Pub. No.: US 2025/0386305 A1
(43) Pub. Date: Dec. 18, 2025

(54) POWER HEADROOM REPORTING IN WIRELESS NETWORKS

(71) Applicant: Samsung Electronics Co., Ltd., Suwon-si (KR)

(72) Inventor: Shiyang Leng, Little Elm, TX (US)

(21) Appl. No.: 19/201,777

(22) Filed: May 7, 2025

Related U.S. Application Data
(60) Provisional application No. 63/659,999, filed on Jun. 14, 2024.
(60) Provisional application No. 63/686,447, filed on Aug. 23, 2024.
(60) Provisional application No. 63/703,075, filed on Oct. 3, 2024.

(51) Int. Cl. H04W 52/36; H04W 52/14; H04W 72/21

(52) U.S. Cl. CPC H04W 52/365; H04W 52/146; H04W 72/21

(57) ABSTRACT

A power headroom report (PHR) procedure is described for a user equipment (UE) in a wireless system. A UE can determine that i) a first MAC entity is not configured with a mode providing two PHRs or ii) the first MAC entity is configured with the mode and a first serving cell to which the first MAC entity belongs is configured with multiple TRP physical uplink shared channel (PUSCH) repetition. The UE determines whether there is at least one real PUSCH transmission at a slot where a PHR MAC CE element is transmitted, determines whether a first TCI state is associated with the at least one real PUSCH transmission, obtain a configured maximum transmission power associated with the first TCI state and transmit, via the first MAC entity, the PHR MAC CE based on at least the obtained configured maximum transmission power associated with the first TCI.

### CROSS-REFERENCE TO RELATED APPLICATIONS

This application claims the benefit of priority from U.S. Provisional Application No. 63/659,999 entitled “POWER HEADROOM REPORTING PROCEDURE FOR SIMULTANEOUS TRANSMISSION ON MULTI-PANEL TERMINAL,” filed Jun. 14, 2024; U.S. Provisional Application No. 63/686,447 entitled “POWER HEADROOM REPORTING PROCEDURE FOR SIMULTANEOUS TRANSMISSION ON MULTI-PANEL TERMINAL,” filed Aug. 23, 2024; and U.S. Provisional Application No. 63/703,075 entitled “POWER HEADROOM REPORTING PROCEDURE FOR SIMULTANEOUS TRANSMISSION ON MULTI-PANEL TERMINAL,” filed Oct. 3, 2024, all which are incorporated herein by reference in their entirety.

### TECHNICAL FIELD

This disclosure relates generally to a wireless communication system, and more particularly to, for example, but not limited to, a power headroom reporting procedure in wireless communication systems.

### BACKGROUND

Power management operations and reports represent a pivotal aspect of any wireless communication system. These systems include, for example, LTE and 5 G New Radio (NR), and upcoming technologies currently coined “6 G”. Current power management solutions and reports can include performing power headroom reports. A user equipment (UE) can measure power currently being used and report a power headroom to a network (e.g., a base station or node (gNB)).

As wireless technologies progress and develop, a standard procedure that can be implemented across all UEs is desired. Specifically, a UE may want to report power headroom to a base station or gNB. However, based on differing capabilities of devices in the wireless system, how to report power headroom and maximum power from a UE to a base station is unclear or not specified.

The description set forth in the background section should not be assumed to be prior art merely because it is set forth in the background section. The background section may describe aspects or embodiments of the present disclosure.

### SUMMARY

An aspect of the present disclosure provides for a user equipment (UE) for facilitating communication in a wireless network, the UE including a processor configured to determine that i) a first medium access control (MAC) entity is not configured with a mode providing two power headroom reports (PHRs) or ii) the first MAC entity is configured with the mode and a first serving cell to which the first MAC entity belongs is configured with multiple transmit and receipt point (TRP) physical uplink shared channel (PUSCH) repetition; determine whether there is at least one real physical uplink shared channel (PUSCH) transmission at a slot where a PHR MAC control element (CE) is transmitted; determine whether a first transmission control indicator (TCI) state is associated with the at least one real PUSCH transmission when there is the at least one real PUSCH transmission at the slot where the PHR MAC CE is transmitted; obtain a configured maximum transmission power associated with the first TCI state in a case that the first TCI state is associated with the at least one real PUSCH transmission; and transmit, via the first MAC entity, the PHR MAC CE based on at least the obtained configured maximum transmission power associated with the first TCI state.

In some embodiments, the processor is further to obtain a configured maximum transmission power associated with a second TCI state in a case that the second TCI state is associated with the at least one real PUSCH transmission.

In at least one embodiment, the processor is further to obtain a value of a type-1 power headroom of the least one real PUSCH transmission associated with the first TCI state, the type-1 power headroom indicating a difference between a UE maximum transmit power and an estimated power for the real PUSCH transmission in a case that the first TCI state is associated with the at least one real PUSCH transmission.

In one embodiment, the processor is further to determine that the first TCI state is not associated with the at least one real PUSCH transmission when there is at least one real PUSCH transmission at the slot where the PHR MAC CE is transmitted. In such embodiments, the processor can obtain a value of the type-1 power headroom of the at least one real PUSCH transmission associated with a second TCI state in a case that the first TCI state is not associated with the at least one real PUSCH transmission.

In at least one embodiment, the processor is further to obtain a value of the type-1 power headroom of a reference PUSCH transmission associated with the first TCI state when there is not at least one real PUSCH transmission at the slot where the PHR MAC CE is transmitted.

In at least one embodiment, the processor is further to obtain a configured maximum transmission power for the reference PUSCH transmission associated with the first TCI state when there is no real PUSCH transmission at the slot where the PHR MAC CE is transmitted.

In one example, the processor is to determine that a second serving cell is configured with a multi-panel scheme.

In at least one example, the multi-panel scheme is a multi-panel scheme spatial division multiplexing (SDM) or a multi-panel scheme single frequency network (SFN).

In one embodiment, the processor is further to determine that a second MAC entity to which a second serving cell belongs is configured with the mode providing two PHRs.

In at least one embodiment, the processor is to determine that a second serving cell is configured with a multi-panel scheme and a second MAC entity to which the second serving cell belongs is configured with the mode.

In some embodiments, the processor is further to determine that a maximum permissible exposure (MPE) report procedure for a frequency range two (FR2) is configured for the MAC entity and if a second serving cell operates on the frequency range two. In such embodiments, the processor can also obtain a value for a MPE associated with the first TCI state when the first TCI state is applied for the real PUSCH transmission.

In one embodiment, the processor is further to obtain a value for a MPE associated with a second TCI state when the second TCI state is applied for the real PUSCH transmission.

In at least one embodiment, the processor is to obtain the value for the MPE associated with the first TCI state when there is no real PUSCH transmission at the slot where the PHR MAC CE is transmitted.

An aspect of the present disclosure provides for a method performed by a user equipment (UE) for facilitating communication in a wireless network, including: determining that i) a first medium access control (MAC) entity is not configured with a mode providing two power headroom reports (PHRs) or ii) the first MAC entity is configured with the mode and a first serving cell to which the first MAC entity belongs is configured with multiple transmit and receipt point (TRP) physical uplink shared channel (PUSCH) repetition; determining whether there is at least one real physical uplink shared channel (PUSCH) transmission at a slot where a PHR MAC control element (CE) is transmitted; determining whether a first transmission control indicator (TCI) state is associated with the at least one real PUSCH transmission when there is the at least one real PUSCH transmission at the slot where the PHR MAC CE is transmitted; obtaining a configured maximum transmission power associated with the first TCI state in a case that the first TCI state is associated with the at least one real PUSCH transmission; and transmitting, via the first MAC entity, the PHR MAC CE based on at least the obtained configured maximum transmission power associated with the first TCI state.

In at least one embodiment, the method further includes obtaining a configured maximum transmission power associated with a second TCI state in a case that the second TCI state is associated with the at least one real PUSCH transmission.

In one embodiment, the method further includes obtaining a value of a type-1 power headroom of the least one real PUSCH transmission associated with the first TCI state, the type-1 power headroom indicating a difference between a UE maximum transmit power and an estimated power for the real PUSCH transmission in a case that the first TCI state is associated with the at least one real PUSCH transmission.

In one or more embodiments, the method further includes determining that the first TCI state is not associated with the at least one real PUSCH transmission when there is at least one real PUSCH transmission at the slot where the PHR MAC CE is transmitted; and obtaining a value of the type-1 power headroom of the at least one real PUSCH transmission associated with a second TCI state in a case that the first TCI state is not associated with the at least one real PUSCH transmission.

In at least one embodiment, the method also includes obtaining a value of the type-1 power headroom of a reference PUSCH transmission associated with the first TCI state when there is not at least one real PUSCH transmission at the slot where the PHR MAC CE is transmitted.

In at least one embodiment, the method includes obtaining a configured maximum transmission power for the reference PUSCH transmission associated with the first TCI state when there is no real PUSCH transmission at the slot where the PHR MAC CE is transmitted.

In one embodiment, the method includes determining that a second serving cell is configured with a multi-panel scheme and a second MAC entity to which the second serving cell belongs is configured with the mode.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process 400 for reporting headroom power in accordance with an embodiment.

FIG. 5 shows an example process 500 for reporting headroom power in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5 G NR systems, 5 G-Advanced (5 G-A) and further improvements and advancements thereof and to the upcoming 6 G communication systems. However, under various circumstances, the described embodiments may also be implemented in any device, system or network that is capable of transmitting and receiving radio frequency (RF) signals according to other technologies, such as the 3 G and 4 G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5 G NR, AMPS, or other known signals that are used to communicate within a wireless, cellular or IoT network, such as one or more of the above-described systems utilizing 3 G, 4 G, 5 G, 6 G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5 G communication systems have been developed and are currently being deployed commercially. 5 G Advanced, as defined in 3GPP Release 18, is yet a further upgrade to aspects of 5 G and has already been introduced as an optimization to 5 G in certain countries. Development of 5 G Advanced is well underway. The development and enhancements of 5 G also can accord processing resources greater overall efficiency, including, by way of example, in high-intensive machine learning environments involving precision medical instruments, measurement devices, robotics, and the like. Due to 5 G and its expected successor technologies, access to one or more application programming interfaces (APIs) and other software routines by these devices are expected to be more robust and to operate at faster speeds.

Among other advantages, 5 G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5 G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5 G can beneficially be transmitted using lower frequency bands, such as below 6 GHZ, to enable more robust and distant coverage and for mobility support (including handoffs and the like). As noted above, various aspects of the present disclosure may be applied to 5 G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5 G communication systems.

In addition, in 5 G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (COMP), reception-end interference cancellation, and the like. As exemplary technologies like neural-network machine learning, unmanned or partially-controlled electric vehicles, or hydrogen-based vehicles begin to emerge, these 5 G advances are expected to play a potentially significant role in their respective implementations. Further advanced access technologies under the umbrella of 5 G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6 G technology, which may roll out commercially at the end of decade or even earlier. 6 G systems are expected to take most or all the improvements brought by 5 G and improve them further, as well as to add new features and capabilities. It is also anticipated that 6 G will tap into uncharted areas of bandwidth to increase overall capacities. As noted, principles of this disclosure are expected to apply with equal force to 6 G systems, and beyond.

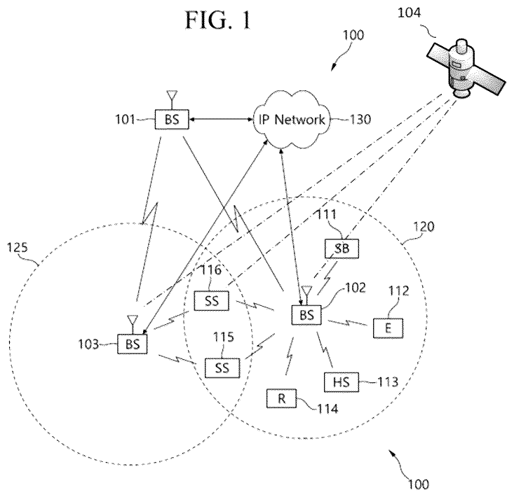

FIG. 1 shows an example of a wireless network 100 in accordance with an embodiment. The embodiment of the wireless network 100 shown in FIG.1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6 G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6 G, 5 G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG.1 illustrates one example of a wireless network 100, various changes may be made to FIG.1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5 G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

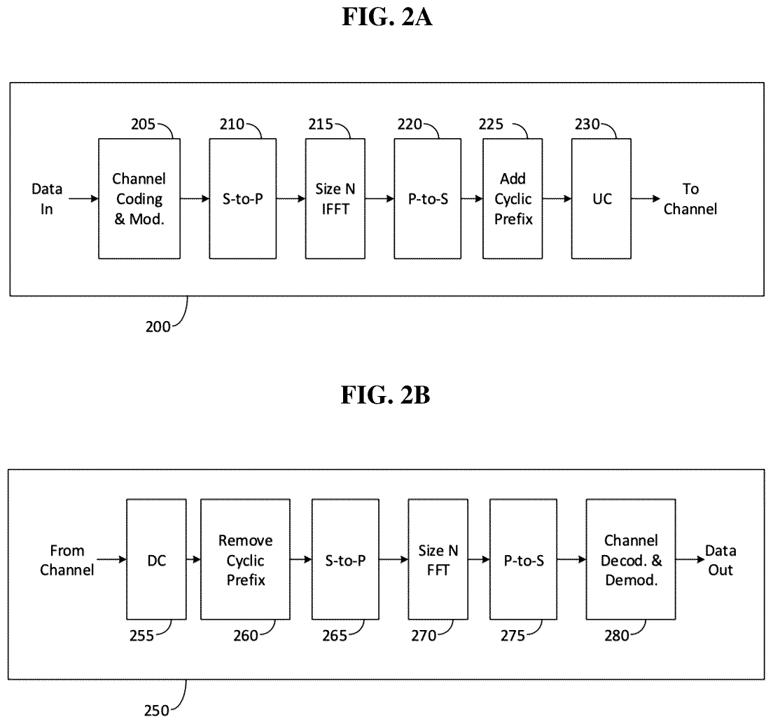

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

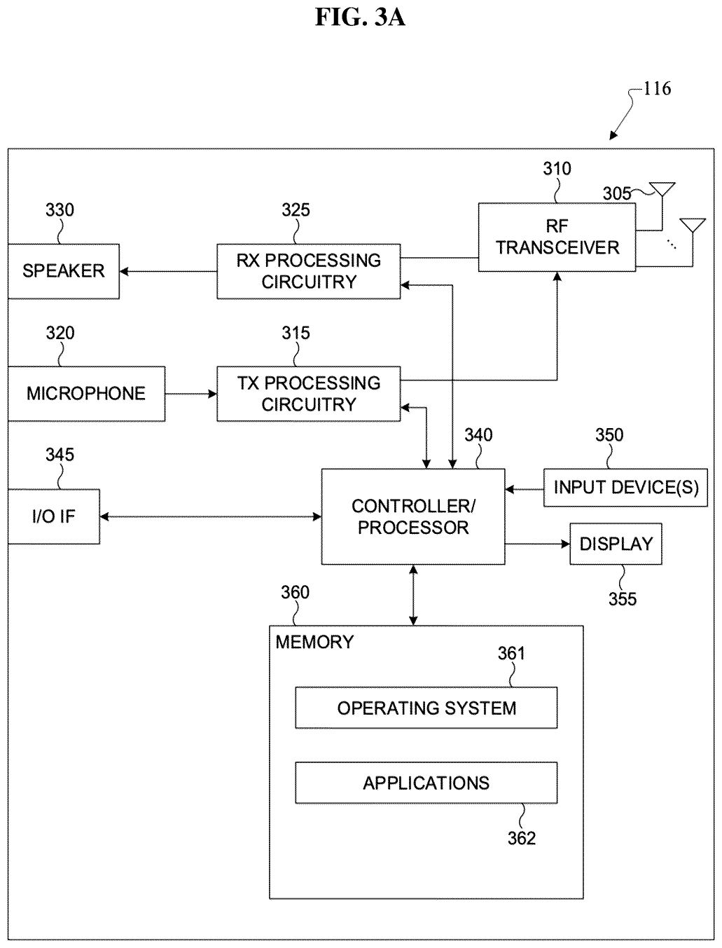

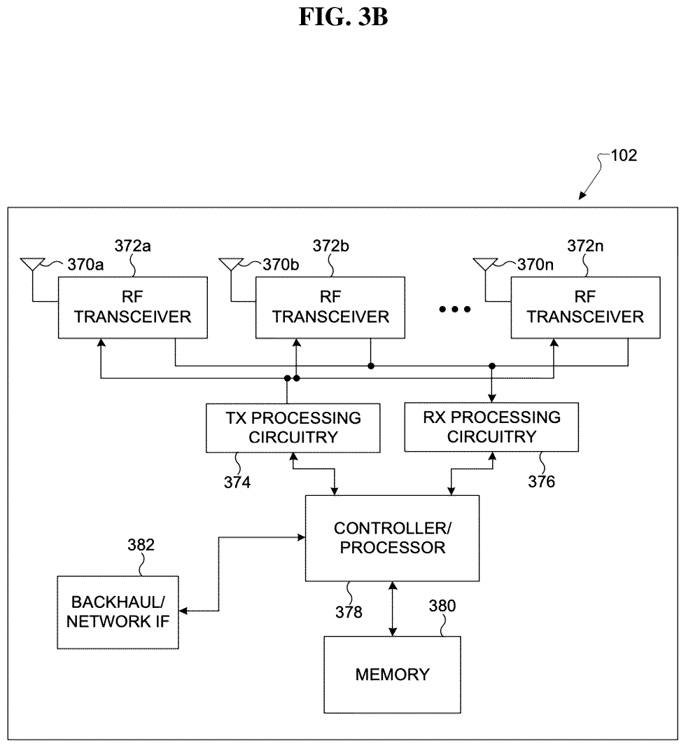

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3 A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUS). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5 G, 5 G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5 G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP TS 38.300 v17.5.0; ii) 3GPP TS 38.331 v17.5.0; iii) 3GPP TS 38.321 v17.5.0; iv) 3GPP TS 38.321 v18.1.0.

3GPP (Third-Generation Partnership Project) has developed technical specifications and standards to define the new 5 G radio-access technology, known as 5 G NR (new radio). In one embodiment, multiple-input multiple-output (MIMO) operations are the key technologies in NR systems and show its success in commercial deployment. In one embodiment, a network can perform a multiple transmit/receive point (multi-TRP) operation by having a serving cell schedule the UE from two TRPs to provide better coverage, reliability, and data rates for downlink and uplink transmissions. In one embodiment, there can be two operation modes supported to schedule multi-TRP transmission. In such embodiments, a first mode can be a single-downlink control information (DCI) where the UE is scheduled by the same DCI for both TRPs and a second mode can be a multi-DCI where the UE is scheduled by independent DCIs from each independent TRP. In one embodiment, the UE can perform a single-DCI multi-TRP simultaneous transmission with multi-panel (STxMP) spatial domain multiplexing (SDM) physical uplink shared channel (PUSCH) transmissions. In such embodiments, different layers of one PUSCH are separately transmitted towards two TRPs. In other embodiments, the UE can perform a single-DCI multi-TRP STxMP single frequency network (SFN) PUSCH transmissions. In such embodiments, same layers of one PUSCH are transmitted towards two TRPs. In some embodiments, the UE can perform multi-DCI based multi-TRP STxMP PUSCH+PUSCH transmissions. In such embodiments, two PUSCHs are transmitted towards two TRPs. Additionally, the UE can use two uplink (UL) grants overlapping in time domain for two PUSCH respectively, each one towards a TRP. In one embodiment, the UE can perform a single-DCI multi-TRP STxMP SFN physical uplink control channel (PUCCH) transmissions. In such embodiments, one PUCCH is transmitted towards two TRPs.

In at least one embodiment, during single-DCI based multi-TRP STxMP operations, a network (NW) configures maximum transmission powers per panel (i.e., indicated transmission configuration indicator (TCI) state). In such embodiments, power headroom reporting (PHR) per panel is used for UL power control. In one embodiment, two power headrooms and two associated configured maximum transmission powers are reported for two TRPs, respectively. In one embodiment, the PH and configured maximum transmission power for multiple number of serving cells are reported via a medium access control (MAC) control element (CE) according to a PHR procedure.

In at least one embodiment, the UE can receive data as part of a dual connectivity (DC) operation. In such embodiments, the UE can report the PH from a reporting MAC entity to a target MAC entity while complying with a configuration of the PHR mode of the reporting MAC entity. However, if the reporting MAC entity is not configured with a two PHR mode, a way to communicate the PH and a PCMAX (e.g., a maximum power the UE is configured to output) is desired.

For example, the present disclosure discusses a way to communicate the PH and P_{CMAX} in a wireless system capable of dual connectivity. Specifically, the disclosure includes an embodiment of a PHR procedure for a single-DCI based multi-TRP STxMP for dual connectivity (DC). In one example, a MAC entity in the system is not configured with a two PHR mode (e.g., twoPHRmode). In such embodiments, if the UE is to report to the MAC entity not configured with the twoPHRmode, the UE transmits to the target MAC entity a PH information (e.g., PHR MAC CE) of a second MAC entity which is configured with the two PHR modes and capable of single-DCI based multi-TRP STxMP. In one embodiment, the UE can report one PH and the associated PCMAX that correspond to one of two indicated TCI states used to transmit PUSCH towards one of two TRPs. In another embodiment, the UE can report two PH and the associated P_{CMAX} that correspond to both indicated TCI states used to transmit PUSCHs towards the two TRPs.

In at least one embodiment, the UE can report a PHR based on receiving a real transmission. For example, a UE can determine the PH and the corresponding P_{CMAX} associated with a first indicated TCI state or a second indicated TCI state from a physical layer if the PUSCH transmission using the first indicated TCI state or second indicated TCI state is a real transmission. That is, when the UE receives the real transmission, the UE can report the corresponding PH and PCMAX based on an indicated TCI state of the real transmission—e.g., determine if the real transmission is associated with the first indicated TCI state or associated with the second indicated TCI state. In some examples, the UE can generate and report the PH information according to the following procedure (procedure 1):
If the medium access control (MAC) entity has uplink (UL) resources allocated for a new transmission, the MAC entity shall:
   1>if it is the first UL resource allocated for a new transmission since the last MAC reset:
      2>start phr-PeriodicTimer
   1>if the Power Headroom reporting procedure determines that at least one PHR has been triggered and not canceled; and
   1>if the allocated UL resources can accommodate the MAC control element (CE) for PHR which the MAC entity is configured to transmit, plus its subheader, as a result of logical channel prioritization (LCP) as defined in clause 5.4.3.1 (of TS38.321 V18.2.0):
      2> if multiplePHR with value true is configured:
         3> for each activated Serving Cell with configured uplink associated with any MAC entity of which the active downlink (DL) bandwidth part (BWP) is not dormant BPW; and
         3> for each activated Serving Cell with configured uplink associated with Evolved Universal Terrestrial Radio Access (E-UTRA) MAC entity:
         4> if this MAC entity is configured with twoPHRMode:
         5> if this Serving Cell is configured with multiplepanelScheme SDM or multipanelSchemeSFN and the MAC entity in this Serving Cell belongs to is configured with twoPHRMode
         6> obtain two values of the Type 1 power headroom for the corresponding uplink carrier as specified in clause 7.7 of TS38.213[6] for NR Serving Cell.
         5> else if this Serving Cell is configured with multiple TRP PUSCH repetition (e.g., Serving Cell is not configured with multiplepanelSchemeSDM or multipanelSchemeSFN) and the MAC entity this Serving Cell belongs to is configured with twoPHRMode:
         6> obtain two values of the Type 1 power headroom for the corresponding uplink carrier as specified in clause 7.7 of TS38.213 [6] for NR Serving Cell
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.213[17] for E-UTRA Serving Cell
         4> else (i.e., this MAC entity is not configured with twoPHRMode):
         5> if this Serving Cell is configured with multiple TRP PUSCH repetition or multiplepanelSchemeSDM or multipanelSchemeSFN and if the MAC entity of this Serving Cell belongs to is configured with twoPHRMode:
         6> if there is at least one real PUSCH transmission at the slot where the PHR MAC CE is transmitted:
         7> if this Serving Cell is configured with multiple TRP PUSCH repetition:
         8> obtain the value of the Type 1 power headroom of the first real transmission of the corresponding uplink carrier as specified in clause 7.7 of TS38.213[6] for NR Serving Cell.
         7> else if this Serving Cell is configured with multiplepanelSchemeSDM or multipanelSchemeSFN:
         8>obtain the value of the Type 1 power headroom of a real transmission associated with either the first TCI-State or the second TCI-State from the physical layer.
         6> else if there is no real PUSCH transmission at the slot where the PHR MAC CE is transmitted:
         7> if this Serving Cell is configured with multiple TRP PUSCH repetition:
         8> obtain the value of the Type 1 power headroom of the reference PUSCH transmission associated with the SRS-ResourceSet with a lower SRS-resourceSetID for the corresponding uplink carrier as specified in clause 7.7 of TS38.213[6] for NR Serving Cell.
         7> else if this Serving Cell is configured with multiplepanelSchemeSDM or multipanelSchemeSFN:
         8>obtain the value of the Type 1 power headroom of the reference PUSCH transmission associated to the first TCI-State from the physical layer.
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.217 [17] for E-UTRA Serving Cell.
         4> if this MAC entity is not configured with phr-AssumedPUSCH-Reporting:
         5> if this MAC entity is configured with twoPHRMode and if this Serving Cell is configured with multiplepanelSchemeSDM or multipanelSchemeSFN:
         6> obtain two values for the corresponding P_{CMAX,f,c,k} fields from the physical layer.
         6> if mpe-reporting-FR2 (e.g., maximum permissible exposure (MPR) reporting for FR2) is configured and this Serving Cell operates on FR2 and this Serving Cell is associated to this MAC entity:
         7> obtain two values for the corresponding MPEₖ fields from the physical layer.
         5> else if this MAC entity is not configured with twoPHRMode and if this Serving Cell is configured with multiplepanelSchemeSDM or multipanelSchemeSFN and the MAC entity this Serving Cell belongs to is configured with twoPHRMode:
         6> obtain the value for the P field corresponding P_{CMAX,f,c,k} to the obtained Type 1 power headroom from the physical layer.

In at least one embodiment, a phr-PeriodicTimer can refer to a timer that controls a periodicity of PHR reporting. In one embodiment, a PHR is triggered when the phr-PeriodicTimer expires. In at least one embodiment, a phr-ProhibitTimer refers to a timer that prevents the UE from reporting PHR too frequently. In some embodiments, the UE can refrain from reporting PHR when the phr-ProhibitTimer is active. In at least one embodiment, phr-Tx-PowerFactorChange can refer to a parameter that defines a threshold for a change in a UE's transmit power. In some embodiments, a PHR is triggered when the change exceeds a threshold value. That is, the UE can initiate a PHR if a timer expires or if a path loss has changed more than the phr-Tx-PowerFactorChange dB. In some embodiments, phr-Type2OtherCell indicates the UE should report Type 2 PHR for the special cell (SpCell) of the other MAC entity. In some embodiments, phr-ModeOtherCG indicates a mode (e.g., real or virtual) used for PHR of activated cells that are part of the other Cell Groups (CG). In some examples, multiplePHR indicates if a UE should use multiple entry PHR MAC CE or a single entry PHR MAC CE. In at least one embodiment, mpe-Reporting-FR2 indicates whether a UE should report maximum permissible exposure (MPE) power management maximum power reduction (P-MPR) in the PHR MAC CE when operating the frequency range 2 (FR2). In some embodiments, mpe-ProhibitTimer refers to a timer specific to MPE, where UE can refrain from reporting MPE when the timer is active. In at least one embodiment, twoPHRMode indicates whether a power headroom should be reported as two PHRs, each associated with a sound reference signal (SRS) resource set. In at least one embodiment, MPE-MPR is a power backoff to meet the MPE FR2 requireemtns for a serving cell operating on FR2.

In at least one embodiment, for the above procedure 1, a type 1 power headroom is a difference between a nominal UE maximum transmit power and an estimated power for uplink scheduling (UL-SCH) transmission per activated Serving Cell, a type 2 power head room is a difference between the nominal UE maximum transmit power and the estimated power for UL-SCH and PUCCH transmission on a special cell (SpCell) of the other MAC entity (e.g., E-UTRA MAC entity), and a type 3 power headroom is a difference between the nominal UE maximum transmit power and the estimated power for the SRS transmission per activated Serving Cell. In at least one embodiment, the above procedure 1 illustrates UE reporting when there is not a MAC entity configured with a two PHR mode (e.g., twoPHRMode). For example, when there is a real PUSCH transmission and the MAC entity is not configured with the two PHR mode, the UE can obtain the Type 1 headroom of the first real transmission associated with either the first TCI-State or the second TCI-State when the serving cell is configured with with multi-panel simultaneous transmission (e.g., multiplepanelSchemeSDM or multipanelSchemeSFN). In some embodiments, there can be no real transmissions. In such embodiments, the UE can obtain the type 1 power headroom of a reference PUSCH transmission associated to the first TCI-State. Accordingly, the UE can report the power headroom even if the MAC entity is not configured for the two PHR mode.

In other embodiments, the UE can obtain the PH and the corresponding P_{CMAX} and associate it with the first indicated TCI-state if there is a real PUSCH transmission. In such embodiments, the UE can associate the PH and the corresponding P_{CMAX} to the second indicated TCI-state from the physical layer if the real transmission is not applied with the first indicated TCI state. For example, the UE can generate the PH information according to the following procedure (procedure 2):
If the medium access control (MAC) entity has uplink (UL) resources allocated for a new transmission, the MAC entity shall:
   1> if it is the first UL resource allocated for a new transmission since the last MAC reset:
      2> start phr-Periodic Timer
   1> if the Power Headroom reporting procedure determines that at least one PHR has been triggered and not canceled; and
   1>if the allocated UL resources can accommodate the MAC control element (CE) for PHR which the MAC entity is configured to transmit, plus its subheader, as a result of logical channel prioritization (LCP) as defined in clause 5.4.3.1 (of TS38.321 V18.2.0):
      2> if multiplePHR with value true is configured:
         3> for each activated Serving Cell with configured uplink associated with any MAC entity of which the active downlink (DL) bandwidth part (BWP) is not dormant BPW; and
         3> for each activated Serving Cell with configured uplink associated with Evolved Universal Terrestrial Radio Access (E-UTRA) MAC entity:
         4> if this MAC entity is configured with twoPHRMode:
         5> if this Serving Cell is configured with multiplepanelSchemeSDM or multipanelSchemeSFN and the MAC entity in this Serving Cell belongs to is configured with twoPHRMode
         6> obtain two values of the Type 1 power headroom for the corresponding uplink carrier as specified in clause 7.7 of TS38.213[6] for NR Serving Cell.
         5> else if this Serving Cell is configured with multiple TRP PUSCH repetition (e.g., Serving Cell is with not configured multiplepanelSchemeSDM or multipanelSchemeSFN) and the MAC entity this Serving Cell belongs to is configured with twoPHRMode:
         6> obtain two values of the Type 1 power headroom for the corresponding uplink carrier as specified in clause 7.7 of TS38.213[6] for NR Serving Cell
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.213[17] for E-UTRA Serving Cell
         4> else (i.e., this MAC entity is not configured with twoPHRMode):
         5> if this Serving Cell is configured with multiple TRP PUSCH repetition or multiplepanelSchemeSDM or multipanelSchemeSFN and if the MAC entity of this Serving Cell belongs to is configured with twoPHRMode:
         6> if there is at least one real PUSCH transmission at the slot where the PHR MAC CE is transmitted:
         7> if this Serving Cell is configured with multiple TRP PUSCH repetition:
         8> obtain the value of the Type 1 power headroom of the first real transmission of the corresponding uplink carrier as specified in clause 7.7 of TS38.213[6] for NR Serving Cell.
         7> else if this Serving Cell is configured with multiplepanelSchemeSDM or multipanelSchemeSFN:
         8> if the PUSCH transmission applying the first TCI-State is a real transmission
         9> obtain the value of the Type 1 power headroom of this real transmission from the physical layer.
         8> else:
         9> obtain the value of the Type 1 power headroom of the real transmission applying the second TCI-State from the physical layer.
         6> else if there is no real PUSCH transmission at the slot where the PHR MAC CE is transmitted:
         7> if this Serving Cell is configured with multiple TRP PUSCH repetition:
         8> obtain the value of the Type 1 power headroom of the reference PUSCH transmission associated with the SRS-ResourceSet with a lower SRS-resourceSetID for the corresponding uplink carrier as specified in clause 7.7 of TS38.213[6] for NR Serving Cell.
         7> else if this Serving Cell is configured with multiplepanelSchemeSDM or multipanelSchemeSFN:
         8>obtain the value of the Type 1 power headroom of the reference PUSCH transmission applying the first TCI-State for NR Serving Cell.
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.217 [17] for E-UTRA Serving Cell.
         4> if this MAC entity is not configured with phr-AssumedPUSCH-Reporting:
         5> if this MAC entity is configured with twoPHRMode and if this Serving Cell is configured with multiplepanelScheme SDM or multipanelSchemeSFN:
         6> obtain two values for the corresponding P_{CMAX,f,c,k} fields from the physical layer.
         6> if mpe-reporting-FR2 (e.g., maximum permissible exposure (MPR) reporting for FR2) is configured and this Serving Cell operates on FR2 and this Serving Cell is associated to this MAC entity:
         7> obtain two values for the corresponding MPE fields from the physical layer.
         5> else if this MAC entity is not configured with twoPHRMode and if this Serving Cell is configured with multiplepanelSchemeSDM or multipanelSchemeSFN and the MAC entity this Serving Cell belongs to is configured with twoPHRMode:
         6> obtain the value for the P field corresponding P_{CMAX,f,c,k} to the obtained Type 1 power headroom from the physical layer.

In some embodiments, the UE can obtain the PH values and the corresponding P_{CMAX} values associated with the first indicated TCI state and the second indicated TCI state from the physical layer. For example, the UE can determine the PH information according to a following procedure (procedure 3):
If the medium access control (MAC) entity has uplink (UL) resources allocated for a new transmission, the MAC entity shall:
   1> if it is the first UL resource allocated for a new transmission since the last MAC reset:
      2> start phr-Periodic Timer
   1> if the Power Headroom reporting procedure determines that at least one PHR has been triggered and not canceled; and
   4>if the allocated UL resources can accommodate the MAC control element (CE) for PHR which the MAC entity is configured to transmit, plus its subheader, as a result of logical channel prioritization (LCP) as defined in clause 5.4.3.1 (of TS38.321 V18.2.0):
      5> if multiplePHR with value true is configured:
         6> for each activated Serving Cell with configured uplink associated with any MAC entity of which the active downlink (DL) bandwidth part (BWP) is not dormant BPW; and
         3> for each activated Serving Cell with configured uplink associated with Evolved Universal Terrestrial Radio Access (E-UTRA) MAC entity:
         4> if this MAC entity is configured with twoPHRMode:
         5> if this Serving Cell is configured with multiplepanelScheme SDM or multipanelSchemeSFN and the MAC entity in this Serving Cell belongs to is configured with twoPHRMode
         6> obtain two values of the Type 1 power headroom for the corresponding uplink carrier as specified in clause 7.7 of TS38.213[6] for NR Serving Cell.
         5> else if this Serving Cell is configured with multiple TRP PUSCH repetition (e.g., Serving Cell is not configured with multiplepanelSchemeSDM or multipanelSchemeSFN) and the MAC entity this Serving Cell belongs to is configured with twoPHRMode:
         6> obtain two values of the Type 1 power headroom for the corresponding uplink carrier as specified in clause 7.7 of TS38.213[6] for NR Serving Cell
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.213[17] for E-UTRA Serving Cell
         4> else (i.e., this MAC entity is not configured with twoPHRMode):
         5> if this Serving Cell is configured with multiple TRP PUSCH repetition and if the MAC entity of this Serving Cell belongs to is configured with twoPHRMode:
         6> if there is at least one real PUSCH transmission at the slot where the PHR MAC CE is transmitted:
         7> obtain the value of the Type 1 power headroom of the first real transmission of the corresponding uplink carrier as specified in clause 7.7 of TS38.213[6] for NR Serving Cell.
         6> else if there is no real PUSCH transmission at the slot where the PHR MAC CE is transmitted:
         7> obtain the value of the Type 1 power headroom of the reference PUSCH transmission associated with the SRS-ResourceSet with a lower SRS-resourceSetID for the corresponding uplink carrier as specified in clause 7.7 of TS38.213[6] for NR Serving Cell.
         5> else if this Serving Cell is configured with multiplepanelScheme SDM or multipanelSchemeSFN and if the MAC entity this Serving Cell belongs to is configured with twoPHRMode:
         6> obtain the value of the Type 1 power headroom for the corresponding uplink carrier as specified in clause 7.7 of TS38.231[6] for NR Serving Cell.
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.217[17] for E-UTRA Serving Cell.
         4> if this MAC entity is not configured with phr-AssumedPUSCH-Reporting:
         5> if this MAC entity is configured with twoPHRMode and if this Serving Cell is configured with multiplepanelSchemeSDM or multipanelSchemeSFN:
         6> obtain two values for the corresponding P_{CMAX,f,c,k} fields from the physical layer.
         6> if mpe-reporting-FR2 (e.g., maximum permissible exposure (MPR) reporting for FR2) is configured and this Serving Cell operates on FR2 and this Serving Cell is associated to this MAC entity:
         7> obtain two values for the corresponding MPEₖ fields from the physical layer.
         5> else if this MAC entity is not configured with twoPHRMode and if this Serving Cell is configured with multiplepanelSchemeSDM or multipanelSchemeSFN and the MAC entity this Serving Cell belongs to is configured with twoPHRMode:
         6> obtain the value for the P field corresponding P_{CMAX,f,c,k} to the obtained Type 1 power headroom from the physical layer

In some embodiments, a mapping pattern is configured by a radio resource control (RRC) field. For example, in a multi-TRP PUSCH repetition operation, the mapping pattern can be configured by the following field and can be in a configured grant (CG) configuration and/or in PUSCH configuration:
mappingPattern-r17 ENUMERATED (cyclicMapping, sequentialMapping) Optional, -Cond SRSsets

In at least one embodiment, the mapping pattern can indicate whether the UE should follow a cyclical mapping pattern (e.g., data mapping where a sequence of events repeats itself in a cycle) or a sequential mapping pattern (e.g., data mapping where a sequence of events progresses linearly, with each event occurring in a specific order without necessarily repeating). In at least one embodiment, the UE can determine whether to follow cyclical mapping pattern or a sequential mapping pattern based on two sound reference signal (SRS) resource sets that are configured in a first set (e.g., srs-ResourceSetToAddModList) or a second set (e.g., srs-ResourceSetToAddModListDCI-0-2) with usage ‘codebook’ or ‘noncodebook’ for PUSCH transmission and the PUSCH transmission occasions are associated with both SRS resources. In at least one embodiment, the field is optional when the UE is configured with two SRS sets in either srs-ResourceSetToAddModList or srs-ResourceSetToAddModListDCI-0-2 with usage codebook or non-codebook. In at least one embodiment, the field is mandatory when the UE is configured with two SRS sets and none of the multiple-panel schemes are configured—e.g., the two SRS sets are configured in either srs-ResourceSetToAddModList or srs-ResourceSetToAddModListDCI-0-2 with usage codebook or non-codebook and none of multipanelSchemeSFN, multipanelSchemeSDM, or STx-2Panel is configured. In at least one embodiment, when the field is active (e.g., or mandatory), the UE can report PH information and the corresponding P_{CMAX} according to the following procedure (procedure 4) (it should be noted portions of the procedure are omitted for the sake of clarity as they are the same as other procedures mentioned above:

### Steps of Procedure 2 Recited Above

6> else if there is no real PUSCH transmission at the slot where the PHR MAC CE is transmitted:
   7> if this Serving Cell is configured with multiple TRP PUSCH repetition:
      8> obtain the value of the Type 1 power headroom of the reference PUSCH transmission associated with the SRS-ResourceSet with a lower SRS-resourceSetID for the corresponding uplink carrier as specified in clause 7.7 of TS38.213[6] for NR Serving Cell.
   7> else if this Serving Cell is configured with multiplepanelSchemeSDM or multipanelSchemeSFN:
      8> obtain the value of the Type 1 power headroom of the reference PUSCH transmission applying the first TCI-State for NR Serving Cell.
   5> else:
6> obtain the value of the Type 1 or Type 3 power headroom for the corresponding uplink carrier as specified in clause 7.7 of TS38.213[6] for NR Serving Cell and clause 5.1.1.2 of TS36.217[17] for E-UTRA Serving Cell.
4> if this MAC entity is configured with phr-AssumedPUCSH-Reporting:
   5> if this MAC entity has UL resources allocated for transmission on this Serving Cell; or
   5> if the other MAC entity, if configured, has UL resources allocated for transmission on this Serving Cell and phr-ModeOtherCG is set to real by upper layers;
6> if dynamic TransformPrecoderFieldPresenceDCI-0-1-r18 or dynamic TransfromPrecoderFieldPresenceDCI-0-2-r18 is set to enabled in the active bandwidth part (BWP) of this serving cell;
   7> obtain the value for the corresponding P_{CMAX,f,c,k} field for assumed PUSCH from the physical layer if available, as specified in clause 7.7 of TS38.213[6]
6> obtain the value for the corresponding P_{CMAX,f,c,k} field from the physical layer
6> if mpe-Reporting-FR2 is configured and this Serving Cell operates on FR2 and this Serving Cell is associated to this MAC entity:
   7> obtain the value for the corresponding MPE field from the physical layer.
4> else (e.g., if this MAC entity is not configured with phr-AssumedPUSCH-Reporting):
   5> if this MAC entity is configured with twoPHRMode and if this Serving Cell belonging to this MAC entity is configured with multiplepanelSchemeSDM or multipanelSchemeSFN:
6> obtain two values for the corresponding P_{CMAX,f,c,k} fields from the physical layer.
6> if mpe-reporting-FR2 is configured and this Serving Cell operates on FR2 and this Serving Cell is associated to this MAC entity:
   7> obtain two values for the corresponding MPEₖ fields from the physical layer.
   5> else (e.g., if this MAC entity is not configured with twoPHRMode):
6> if this MAC entity has UL resources allocated for transmission on this Serving Cell; or
6> if the other MAC entity, if configured, has UL resources allocated for transmission on this Serving Cell and phr-ModeOtherCG is set to real by upper layers:
   7> obtain the value for the corresponding P_{CMAX,f,c,k} field from the physical layer.
   7> if mpe-Reporting-FR2 is configured and this Serving Cell operates on FR2 and this Serving Cell is associated to this MAC entity:
      8> obtain the value for the corresponding MPE field from the physical layer
   7> if mpe-Reporting-FR2-r17 is configured and this Serving Cell operates on FR2 and this Serving Cell is associated to this MAC entity:
      8> obtain the value for the corresponding MPE field from the physical layer;
      8> obtain the value for the corresponding Resources field from the physical layer
   7> if dpc-Reproting-FR1 is configured and ΔP_{PowerClass}/ΔP_{PowerClass, CA}/ΔP_{PowerClass, EN-DC}/ΔP_{PowerClass, NR-DC} reporting is triggered and this Serving Cell is associated to this MAC entity:
      8> obtain the value for the corresponding DPC field(s) from the physical layer.
3> if phr-Type2OtherCell with value true is configured:
4> if the other MAC entity is E-UTRA MAC entity;
   5> obtain the value of the Type 2 power headroom for the SpCell of the other MAC entity (e.g., E-UTRA MAC entity)
   5> if phr-ModeOtherCG is set to real by upper layers;
6> obtain the value for the corresponding P_{CMAX,f,c,k} field for the SpCell of the other MAC entity (e.g., E-UTRA MAC entity) from the physical layer
3> if this MAC entity is configured with mpe-Reporting-FR2-r17:
4> instruct the Multiplexing and Assembly procedure to generate and transmit the Enhanced Multiple entry PHR as defined in clause 6.1.3.49 based on the values reported by the physical layer.
3> else if the MAC entity is configured with twoPHRMode:
4> if any Serving Cell belonging to this MAC entity is configured with multipanelSchemeSDM or multipanelSchemeSFN:
   5> instruct the Multiplexing and Assembly procedure to generate and transmit the Enhanced Multiple Entry PHR for multiple TRP STx2P MAC CE as defined in clause 6.1.3.82 based on the values reported by the physical layer.
4> else:
   5> instruct the Multiplexing and Assembly procedure to generate and transmit the Enhanced Multiple Entry PHR for multiple TRP MAC CE as defined in clause 6.1.3.51 based on values reported by the physical layer.
3> else if this MAC entity is configured with phr-AssumedPUSCH-Reporting:
4> instruct the Multiplexing and Assembly procedure to generate and transmit the Multiple Entry PHR with assumed PUSCH MAC CE as defined in clause 6.1.3.79 based on the values reported by the physical layer.
3> else:
4> instruct the Multiplexing and Assembly procedure to generate and transmit the Multiple Entry PHR MAC CE as defined in clause 6.1.3.9 based on the values reported by the physical layer

As described above, as wireless technology progresses and improves, different devices and equipment in a system can have different capabilities. For example, a system can include two MAC entities, e.g., a first MAC entity and a second MAC entity. In some embodiments, the first MAC entity transmitting a PHR is configured with a two PHR mode (e.g., twoPHRMode) but none of the Serving Cells belonging to the first MAC entity are configured with mTRP multi-panel scheme—e.g., a Serving Cell belonging to the first MAC entity is configured for mTRP PUSCH repetition. In such examples, a serving cell configured with STx2P multi-panel scheme (e.g., a feature in release 18) can belong to a second MAC entity configured with a two PHR mode (e.g., twoPHRmode). That is, a UE can be serviced by a first MAC entity configured for mTRP PUSCH and a second MAC entity configured for STx2P multi-panel scheme. In such embodiments, two type 1 PH values and one P_{CMAX} value are determined from a lower layer and r17 PHR MA CE for mTRP is generated. However, it not clear which P_{CMAX} is determined. That is, the serving cell is associated with two MAC entity's having different P_{CMAX} values. In one embodiment, a UE can determine a P_{CMAX} associated to a Type 1 PH if there is a real PUSCH transmission or there is no real PUSCH transmission for a first joint/UL TCI applied. In other embodiments, the UE can determine a P_{CMAX} associated to a Type 1 PH for the real PUSCH transmission for a second joint/UL TCI applied—e.g., the UE can determine a Type 1 PH for the first joint/UL TCI if the first joint/UL TCI is applied for a real PUSCH transmission or if there is no real PUSCH transmission and the UE can determine a Type 1 PH for the second joint/UL TCI if the second joint/UL TCI is applied for the real PUSCH transmission. In such embodiments, the corresponding MPE is reported. In one embodiment, this process is illustrated by procedure 5 below. In other embodiments, a P_{CMAX} associated to the Type 1 PH for the first joint/UL TCI is obtained and the corresponding MPE is reported. In one embodiment, this process is illustrated by procedure 6 below. In one example, a UE can follow the following procedure while reporting PHR information (e.g., procedure 5):
If the MAC entity has UL resources allocated for a new transmission, the MAC entity shall:
   1> if it is the first UL resource allocated for a new transmission since the last MAC reset:
      2> start phr-PeriodicTimer
   1> if the Power Headroom reporting procedure determines that at least one PHR has been triggered and not canceled; and
   1> if the allocated UL resources can accommodate the MAC control element (CE) for PHR which the MAC entity is configured to transmit, plus its subheader, as a result of logical channel prioritization (LCP) as defined in clause 5.4.3.1 (of TS38.321 V18.2.0):
      2> if multiplePHR with value true is configured:
         3> for each activated Serving Cell with configured uplink associated with any MAC entity of which the active downlink (DL) bandwidth part (BWP) is not dormant BPW; and
         3> for each activated Serving Cell with configured uplink associated with Evolved Universal Terrestrial Radio Access (E-UTRA) MAC entity:
         4> if this MAC entity is configured with twoPHRMode:
         5> if this Serving Cell is configured with multiplepanelScheme SDM or multipanelSchemeSFN and the MAC entity in this Serving Cell belongs to is configured with twoPHRMode
         6> obtain two values of the Type 1 power headroom for the corresponding uplink carrier as specified in clause 7.7 of TS38.213[6] for NR Serving Cell.
         5> else if this Serving Cell is configured with multiple TRP PUSCH repetition (e.g., Serving Cell is not configured with multiplepanelSchemeSDM or multipanelSchemeSFN) and the MAC entity this Serving Cell belongs to is configured with twoPHRMode:
         6> obtain two values of the Type 1 power headroom for the corresponding uplink carrier as specified in clause 7.7 of TS38.213[6] for NR Serving Cell
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.213[17] for E-UTRA Serving Cell
         4> else (i.e., this MAC entity is not configured with twoPHRMode):
         5> if this Serving Cell is configured with multiple TRP PUSCH repetition or multiplepanelSchemeSDM or multipanelSchemeSFN and if the MAC entity of this Serving Cell belongs to is configured with twoPHRMode:
         6> if there is at least one real PUSCH transmission at the slot where the PHR MAC CE is transmitted:
         7> if this Serving Cell is configured with multiplepanelSchemeSDM or multipanelSchemeSFN:
         8> if the first TCI-State or TCI-UL-State is applied for a real PUSCH transmission:
         9> obtain the value of the Type 1 power headroom of this real transmission associated with the first TCI-State or TCI-UL-State for the corresponding uplink carrier as specified in clause 7.7 of TS 38.213[6] for NR serving cell.
         8> else:
         9> obtain the value of the Type 1 power headroom of the real transmission associated with the second TCI-State or TCI-UL-State for the corresponding uplink carrier as specified in clause 7.7 of TS 38.213[6] for NR serving cell.
         6> else if there is no real PUSCH transmission at the slot where the PHR MAC CE is transmitted:
         7> else if this Serving Cell is configured with multiplepanelSchemeSDM or multipanelSchemeSFN:
         8> obtain the value of the Type 1 power headroom of the reference PUSCH transmission associated with the first TCI-State or TCI-UL-State for the corresponding uplink carrier as specified in clause 7.7 of TS 38.213[6] for NR serving cell.
         7> if this Serving Cell is configured with multiple TRP PUSCH repetition:
         8> obtain the value of the Type 1 power headroom of the reference PUSCH transmission associated with the SRS-ResourceSet with a lower SRS-resourceSetID for the corresponding uplink carrier as specified in clause 7.7 of TS38.213[6] for NR Serving Cell.
         5> else:
         6> obtain the value of the Type 1 or Type 3 power headroom for the corresponding uplink carrier as specified in clause 7.7 of TS38.213[6] for NR Serving Cell and clause 5.1.1.2 of TS36.217[17] for E-UTRA Serving Cell.
         4> if this MAC entity is configured with phr-AssumedPUCSH-Reporting:
         5> if this MAC entity has UL resources allocated for transmission on this Serving Cell; or
         5> if the other MAC entity, if configured, has UL resources allocated for transmission on this Serving Cell and phr-ModeOtherCG is set to real by upper layers;
         6> f dynamicTransformPrecoderFieldPresenceDCI-0-1-r18 or dynamicTransfromPrecoderFieldPresenceDCI-0-2-r18 is set to enabled in the active bandwidth part (BWP) of this serving cell;
         7> obtain the value for the corresponding P_{CMAX,f,c,k} field for assumed PUSCH from the physical layer if available, as specified in clause 7.7 of TS38.213[6]
         6> obtain the value for the corresponding P_{CMAX,f,c,k} field from the physical layer
         6> if mpe-Reporting-FR2 is configured and this Serving Cell operates on FR2 and this Serving Cell is associated to this MAC entity:
         7> obtain the value for the corresponding MPE field from the physical layer.
         4> else (e.g., if this MAC entity is not configured with phr-AssumedPUSCH-Reporting):
         5> if this MAC entity is configured with twoPHRMode and if this Serving Cell belonging to this MAC entity is configured with multiplepanelSchemeSDM or multipanelSchemeSFN:
         6> obtain two values for the corresponding P_{CMAX,f,c,k} fields from the physical layer.
         6> if mpe-reporting-FR2 is configured and this Serving Cell operates on FR2 and this Serving Cell is associated to this MAC entity:
         7> obtain two values for the corresponding MPEₖ fields from the physical layer.
         5> else if this MAC entity is configured with twoPHRMode and no Serving Cell belonging to this MAC entity is configured with multiplepanelSchemeSDM or multipanelSchemeSFN, and if this Serving Cell belongs to the other MAC entity and is configured with multiplepanelSchemeSDM or multipanelSchemeSFN:
         6> if the first TCI-State or TCI-UL-State is applied for a real PUSCH transmission or if there is no real PUSCH transmission at the slot where the PHR MAC CE is transmitted:
         7> obtain the value for the P_{CMAX,f,c} field for the PUSCH transmission associated to the first TCI-State or TCI-UL-State from the physical layer.
         6> else if the second TCI-State or TCI-UL-State is applied for a real PUSCH transmission at the slot where the PHR MAC CE is transmitted:
         7> obtain the value for the P_{CMAX,f,c} field for the PUSCH transmission associated to the second TCI-State or TCI-UL-State from the physical layer.
         6> if mpe-Reporting-FR2 is configured for the MAC entity this Serving Cell belongs to and this Serving Cell operates on FR2:
         7> obtain the value for the corresponding MPE field from the physical layer.
         5> else:
         6> if this MAC entity has UL resources allocated for transmission on this Serving Cell; or
         6> if the other MAC entity, if configured, has UL resources allocated for transmission on this Serving Cell and phr-ModeOtherCG is set to real by upper layers:
         7> obtain the value for the corresponding P_{CMAX,f,c,k} field from the physical layer.
         7> if mpe-Reporting-FR2 is configured and this Serving Cell operates on FR2 and this Serving Cell is associated to this MAC entity:
         8> obtain the value for the corresponding MPE field from the physical layer
         7> if mpe-Reporting-FR2-r17 is configured and this Serving Cell operates on FR2 and this Serving Cell is associated to this MAC entity:
         8> obtain the value for the corresponding MPE field from the physical layer;
         8> obtain the value for the corresponding Resources field from the physical layer
         7> if dpc-Reproting-FR1 is configured and ΔP_{PowerClass}/ΔP_{PowerClass, CA}/ΔP_{PowerClass, EN-DC}/ΔP_{PowerClass, NR-DC} reporting is triggered and this Serving Cell is associated to this MAC entity:
         8> obtain the value for the corresponding DPC field(s) from the physical layer.
         3> if phr-Type2OtherCell with value true is configured:
         4> if the other MAC entity is E-UTRA MAC entity;
         5> obtain the value of the Type 2 power headroom for the SpCell of the other MAC entity (e.g., E-UTRA MAC entity)
         5> if phr-ModeOtherCG is set to real by upper layers;
         6> obtain the value for the corresponding P_{CMAX,f,c,k} field for the SpCell of the other MAC entity (e.g., E-UTRA MAC entity) from the physical layer
         3> if this MAC entity is configured with mpe-Reporting-FR2-r17:
         4> instruct the Multiplexing and Assembly procedure to generate and transmit the Enhanced and Multiple entry PHR as defined in clause 6.1.3.49 based on the values reported by the physical layer.
         3> else if the MAC entity is configured with twoPHRMode and any Serving Cell belonging to this MAC entity is configured with multipanelSchemeSDM or multipanelSchemeSFN:
         4> instruct the Multiplexing and Assembly procedure to generate and transmit the Enhanced Multiple Entry PHR for multiple TRP STx2P MAC CE as defined in clause 6.1.3.82 based on the values reported by the physical layer.
         3> else if this MAC entity is configured with twoPHRMode and any Serving Cell belonging to MAC entity is configured with multiple TRP PUSCH repetition:
         4> instruct the Multiplexing and Assembly procedure to generate and transmit the Enhanced Multiple Entry PHR for multiple TRP MAC CE as defined in clause 6.1.3.51 based on values reported by the physical layer.
         3> else if this MAC entity is configured with phr-AssumedPUSCH-Reporting:
         4> instruct the Multiplexing and Assembly procedure to generate and transmit the Multiple Entry PHR with assumed PUSCH MAC CE as defined in clause 6.1.3.79 based on the values reported by the physical layer.
         3> else:
         4> instruct the Multiplexing and Assembly procedure to generate and transmit the Multiple Entry PHR MAC CE as defined in clause 6.1.3.9 based on the values reported by the physical layer.
      2> else (e.g., Single Entry PHRformat is used):
         3> if this MAC entity is configured with twoPHRMode for multiple TRP PUSCH repetition or multipanelSchemeSDM or multipanelSchemeSFN:
         4> obtain two values of the Type 1 power headroom from the physical layer for the corresponding uplink carrier of the primary cell (Pcell).
         3> else:
         4> obtain the value of the Type 1 power headroom from the physical layer for the corresponding uplink carrier of the PCell.
         3> if this MAC entity is configured with phr-AssumedPUSCH-Reporting:
         4> if dynamic TransformPrecoderFieldPresenceDCI-0-1-r18 or dynamic TransfromPrecoderFieldPresenceDCI-0-2-r18 is set to enabled in the active bandwidth part (BWP) of this serving cell:
         5> obtain the value for the corresponding P_{CMAX,f,c,k} field for assumed PUSCH from the physical layer if available, as specified in clause 7.7 of TS38.213[6]
         3> if this MAC entity is configured with twoPHRMode and if this Serving Cell is configured with multipanelSchemeSDM or multipanelSchemeSFN:
         4> obtain two values for the corresponding P_{CMAX,f,c,k} fields from the physical layer.
         4> if mpe-Reporting-FR2 is configured and this Serving Cell operates on FR2 and this Serving Cell is associated to this MAC entity:
         5> obtain two values for the corresponding MPEₖ fields from the physical layer.
         3> else:
         4> obtain the value for the corresponding P_{CMAX,f,c} field from the physical layer
         4> if mpe-Reporting-FR2 is configured and this Serving Cell operates on FR2:
         5> obtain the value for the corresponding MPE field from the physical layer;
         4> if mpe-Reporting-FR2-r17 is configured and this Serving Cell operates on FR2 and this Serving Cell is associated to this MAC entity:
         5> obtain the value for the corresponding MPE_{f} field from the physical layer
         5> obtain the value for the corresponding Resource_{f} field from the physical layer.
         4> if dpc-Reporting-FR1 is configured and this Serving Cell operates on FR1:
         5> obtain the value for the corresponding DPC (e.g., an adjustment to maximum output power for a given power class for a Serving Cell operating on FR1) field from the physical layer.
         3> if this MAC entity is configured with mpe-Reporting-FR2-r17:
         4> instruct the instruct the Multiplexing and Assembly procedure to generate and transmit the Enhanced Single Entry PHR as defined in clause 6.1.3.48 based on the values reported by the physical layer.
         3> else if this MAC entity is configured with twoPHRMode and if this Serving Cell is configured with multipanelSchemeSDM or multipanelSchemeSFN:
         4> instruct the Multiplexing and Assembly procedure to generate and transmit the Enhanced Single Entry PHR for multiple TRP STx2P MAC CE as defined in clause 6.1.3.81 based on values reported by the physical layer.
         3> else if this MAC entity is configured with twoPHRMode and if this Serving Cell is configured with multiple TRP PUSCH repetition:
         4> instruct the Multiplexing and Assembly procedure to generate and transmit the Enhanced Single Entry PHR for multiple TRP MAC CE as defined in clause 6.1.3.50 based on the values reported by the physical layer.
         3> if this MAC entity is configured with phr-AssumedPUSCH-Reporting:
         4> instruct the Multiplexing and Assembly procedure to generate and transmit the Single Entry PHR with assumed PUSCH MAC CE as defined in clause 6.1.3.78 based on the values reported by the physical layer.
         3> else:
         4> instruct the Multiplexing and Assembly procedure to generate and transmit the Single Entry PHR MAC CE as defined in clause 6.1.3.8 based on the values reported by the physical layer.
      2> if this PHR report is an MPE Power Management Maximum Power Reduction (P-MPR) report:
         3> start or restart the mpe-ProhibitTimer;
         3> cancel triggered MPE P-MPR reporting for Serving Ceels included in the PHR MAC CE.
      2> start or restart phr-Periodic Timer
      2> start or restart phr-ProhibitTimer
      2> cancel all triggered PHR(s)

In at least one embodiment, all triggered PHR(s) are canceled based on an ongoing small data transmission (SDT) procedure as defined in clause 5.27 and the UL grants can accommodate all pending data available for transmission but is not sufficient to additionally accommodate the PHR MAC CE.

As described above, in other embodiments, a P_{CMAX} associated to the Type 1 PH for the first joint/UL TCI is obtained and the corresponding MPE is reported. In one embodiment, this process is illustrated by procedure 6 shown here (it should be noted that steps of procedure 6 that are identical to procedure 5 are omitted for the sake of clarity—e.g., to show the difference between procedure 5 and procedure 6):

### Steps of Procedure 6 Are Identical to Procedure 5 Up This Point and Are Omitted for the Sake of Clarity

4> else (e.g., if this MAC entity is not configured with phr-AssumedPUSCH-Reporting):
   5> if this MAC entity is configured with twoPHRMode and if this Serving Cell belonging to this MAC entity is configured with multiplepanelSchemeSDM or multipanelSchemeSFN:
      6> obtain two values for the corresponding P_{CMAX,f,c,k} fields from the physical layer.
      6> if mpe-reporting-FR2 is configured and this Serving Cell operates on FR2 and this Serving Cell is associated to this MAC entity:
         7> obtain two values for the corresponding MPEₖ fields from the physical layer.
   5> else if this MAC entity is configured with twoPHRMode and no Serving Cell belonging to this MAC entity is configured with multiplepanelSchemeSDM or multipanelSchemeSFN, and if this Serving Cell belongs to the other MAC entity and is configured with multiplepanelSchemeSDM or multipanelSchemeSFN:
      6> obtain the value for the P_{CMAX,f,c} field for the PUSCH transmission associated to the first TCI-State or TCI-UL-State from the physical layer.
      6> if mpe-Reporting-FR2 is configured for the MAC entity this Serving Cell belongs to and this Serving Cell operates on FR2:
         7> obtain the value for the corresponding MPE field from the physical layer.

### Remaining Steps of Procedure 6 Are Identical to Procedure 5 and Omitted for the Sake of Clarity

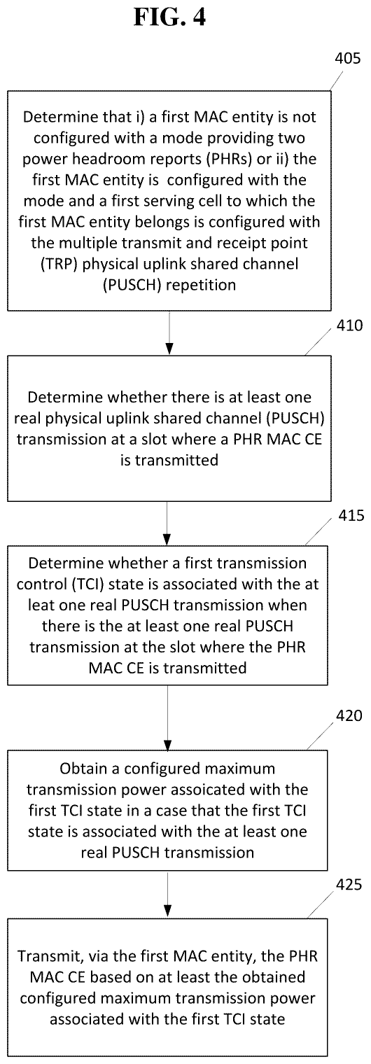

FIG. 4 shows an example process 400 for power headroom reporting in accordance with an embodiment. For explanatory and illustration purposes, the example processes 400 may be performed by a UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods.

Referring to FIG. 4, the process 400 may begin in operation 405. In operation 405, a UE (e.g., a processor of the UE) determines that i) a first medium access control (MAC) entity is not configured with a mode providing two power headroom reports (PHRs) or ii) the first MAC entity is configured with the mode and a first serving cell to which the first MAC entity belongs is configured with multiple transmit and receipt point (TRP) physical uplink shared channel (PUSCH) repetition. That is, as described above, some MAC entity are capable of reporting two power headroom reports while others cannot—e.g., some MAC entities are capable of a twoPHRmode (e.g., reporting the two PHRs) while other MAC entities are not configured with the twoPHRmode. In at least one embodiment, the UE is configured to (e.g., capable of) transmitting data simultaneously from a first antenna panel and a second antenna panel—e.g., the UE is capable of simultaneous transmission with multipanel (STxMP) operations. In at least one embodiment, the first serving cell associated with the UE is configured with multi-panel transmission (e.g., configured with multiplepanelSchemeSDM or multipanelSchemeSFN). That is, as described with reference to FIG. 3, serving cells can be capable of TRP PUSCH repetition or multi-panel schemes. For example, the first serving cell can be capable of a multi-panel scheme spatial division multiplexing (SDM) or a multi-panel scheme single frequency network (SFN) scheme.

At operation 410, a UE determines whether there is at least one real physical uplink shared channel (PUSCH) transmission at a slot where a PHR MAC control element (CE) is transmitted. That is, the UE can determine if a transmission at a slot where the PHR MAC CE is transmitted is real or not.

At operation 415, the UE can determine that a first transmission control indicator (TCI) state is associated with the at least one real PUSCH transmission when there is at least one real PUSCH transmission at the slot where the PHR MAC CE is transmitted.

At operation 420, the UE can obtain a configured maximum transmission power (e.g., P_{CMAX}) associated with the first TCI state in a case that the first TCI state is associated with the at least one real PUSCH transmission. That is, if the first TCI-State or TCI-UL-State is applied for a real PUSCH transmission at a slot where the PHR MAC CE is transmitted, the UE can obtain the value for the P_{CMAX,f,c} field for the PUSCH transmission associated to the first TCI-State or TCI-UL-State from the physical layer. In some embodiments, the UE can further determine if a maximum permissible exposure (MPE) report procedure for a frequency range two (e.g., FR2) is configured for the MAC entity and if this serving cell operates on the frequency range two. In such embodiments, if the MPE report parameter is configured, the UE can obtain a value for a MPE associated with the first TCI state when the first TCI state is applied for the real PUSCH transmission. In at least one embodiment, the UE can obtain a value of a type-1 power headroom of the real PUSCH transmission, the type-1 power headroom indicating a difference between a UE maximum transmit power and an estimated power for the real PUSCH transmission, in a case that the first TCI state is associated with the at least one real PUSCH transmission. That is, as described above, a type 1 power headroom is a difference between a nominal UE maximum transmit power and an estimated power for uplink scheduling (UL-SCH) transmission per activated Serving Cell. In this case, the UE can determine the type-1 power headroom of the real PUSCH transmission when the real PUSCH transmission associated with the first TCI state is received at the PHR MAC CE slot.

At operation 425, the UE (e.g., a transceiver of the UE) can transmit, via the first MAC entity, the PHR MAC CE based on at least the obtained configured maximum transmission power associated with the first TCI state. In some embodiments, the UE can transmit via the first MAC entity, the value of the type-1 power headroom of the real PUSCH transmission.

In at least one embodiment, the UE can obtain a configured maximum transmission power associated with a second TCI state in a case that the second TCI state is associated with the at least one real PUSCH transmission. That is, in some embodiments, the UE can determine that the second TCI state is applied for the real PUSCH transmission when there is at least one real PUSCH transmission at the slot where the PHR MAC CE is transmitted. In other embodiments, the UE can determine the first TCI state is not applied or associated with the at least one real PUSCH transmission. For example, the UE can obtain a value of the type-1 power headroom of the real PUSCH transmission associated with the second TCI state in a case that the first TCI state is not associated with the at least one real PUSCH transmission. In some embodiments, the UE, via the first MAC entity, transmits, the PHR MAC CE based on the obtained value of the type-1 power headroom of the real PUSCH transmission associated with the second TCI state. In some embodiments, if the MPE report parameter is configured, the UE can obtain a value for a MPE associated with the second TCI state when the second TCI state is applied for the real PUSCH transmission.

In at least one embodiment, the UE can also determine a corresponding maximum transmit power (e.g., P_{CMAX}) associated with the first TCI state or the second TCI state. That is, when there is a real PUSCH transmission, the UE can determine if the real PUSCH transmission is associated with the first TCI state or the second TCI state, and determine the corresponding maximum transmit power. For example, the UE can obtain a configured maximum transmission power associated with the second TCI state. In other embodiments, the UE can obtain a configured maximum transmission power associated with the first TCI state. In either case, the UE can transmit the corresponding maximum transmission power to the serving cell.

In some embodiments, the UE can obtain a value of the type-1 power headroom of a reference PUSCH transmission associated with the first TCI state when there is no real PUSCH transmission at the slot where the PHR MAC CE is transmitted. That is, in some embodiments, the UE can determine there is no real PUSCH transmission at the PHR MAC CE slot. In such embodiments, the UE can obtain the value of the type-1 power headroom for the reference PUSCH transmission instead of the type-1 power headroom of the real PUSCH transmission. In some embodiments, when the UE determines there is not at least one real PUSCH transmission, the UE can obtain a configured maximum transmission power for the reference PUSCH transmission associated with the first TCI state when there is no real PUSCH transmission at the slot where the PHR MAC CE is transmitted. In at least one embodiment, if the MPE report parameter is configured, the UE can obtain a value for the MPE associated with the first TCI state when there is no real PUSCH transmission at the slot where the PHR MAC CE is transmitted.

That is, either the UE can determine there is a real PUSCH transmission associated with the first TCI state, a real PUSCH transmission associated with the second TCI state, or that there is no real PUSCH transmission. For example, if the UE determines the real transmission is associated with a first TCI state, the UE can determine the PH and the corresponding P_{CMAX} associated with the first TCI state based at least in part on determining the real transmission is associated with the first TCI state. That is, if the first TCI-State or TCI-UL-State is applied for a real PUSCH transmission, the UE can obtain the value of the type I power headroom of the real PUSH transmission associated with the first TCI-State or TCI-UL-State for the corresponding uplink carrier. In other embodiments, if the UE determines the real transmission is associated with the second TCI state, the UE can determine the PH and the corresponding P_{CMAX} associated with the second TCI state based at least in part on determining the real transmission is not associated with the first TCI state. That is, if the first TCI-State or TCI-UL-State is not applied for the real PUSCH transmission, the UE can obtain the value of the Type I power headroom associated with the second TCI-State or TCI-UL-State for the corresponding uplink carrier. In some embodiments, the UE can determine the transmission is not a real transmission. In such embodiments, the UE can determine the PH and the corresponding P_{CMAX} associated with the first TCI state of a reference transmission based at least in part on determining the transmission is not a real transmission. That is, when the serving cell is configured with multiplepanelSchemeSDM or multipanelSchemeSFN, and there is no real transmission, the UE can obtain the value of the Type I power headroom of a reference PUSCH transmission associated with the first TCI-State or TCI-UL-State for the corresponding uplink carrier.

In at least one embodiment, the UE can determine that a second serving cell is configured with a multi-panel scheme. In some examples, the multi-panel scheme is a multi-panel scheme spatial division multiplexing (SDM) or a multi-panel scheme single frequency network (SFN). In some embodiments, the processor can also determine that a second MAC entity to which the serving cell belongs to is configured with the mode providing two PHRs.

In at least one embodiment, the serving cell can be configured with multiple transmission/reception point (TRP) physical uplink shared channel (PUSCH) repetition. In such embodiments, the UE is configured (e.g., capable of) transmitting a first set of repetition to a first device and transmit a second set of repetition to a second device. In some embodiments, the UE can further determine the transmission is a real transmission. In such embodiments, when the serving cell is configured with multiple TRP PUSCH repetition, the UE can obtain the value of the Type I power headroom of the first real transmission of the corresponding uplink carrier. In other embodiments, the UE can determine the received transmission is not a real transmission. In such embodiments, the UE can determine a second PH and second corresponding (P_{CMAX}) associated with a reference transmission associated with a first set of sounding reference signals (SRS) or determine a third PH and third corresponding (P_{CMAX}) associated with a corresponding uplink carrier. That is, when the when the serving cell is configured with multiple TRP PUSCH repetition and the transmission is not real, the UE can obtain the value of the Type I power headroom of the reference PUSCH transmission associated with the sounding reference signal (SRS) resource set (e.g., SRS-ResourceSet) or the value of the type 3 power headroom for the corresponding uplink carrier.

In at least one embodiment, the UE can determine that the serving cell is configured with the multi-panel scheme and a second MAC entity to which the serving cell belongs to is configured with the mode.

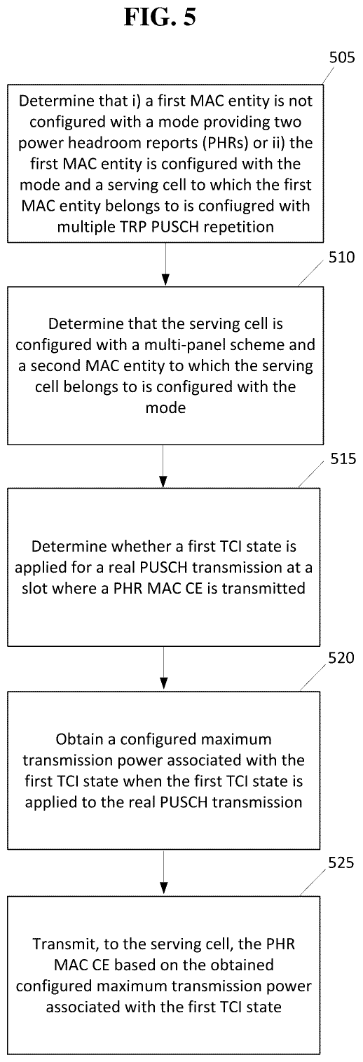

FIG. 5 shows an example process 500 for power headroom reporting in accordance with an embodiment. For explanatory and illustration purposes, the example processes 500 may be performed by a UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods.

Referring to FIG. 5, the process 500 may begin in operation 505. In operation 505, a UE determines that i) a first medium access control (MAC) entity is not configured with a mode providing two power headroom reports (PHRs) or ii) the first MAC entity is configured with the mode and a serving cell to which the first MAC entity belongs to is configured with multiple transmit and receipt points (TRP) physical uplink shared channel (PUSCH) repetition. That is, as described with reference to FIG. 3, serving cells can be capable of TRP PUSCH repetition or multi-panel schemes. For example, the serving cells can be capable of a multi-panel scheme spatial division multiplexing (SDM) or a multi-panel scheme single frequency network (SFN) scheme. Additionally, as described above, some MAC entity are capable of reporting two power headroom reports while others cannot—e.g., some MAC entities are capable of a twoPHRmode (e.g., reporting the two PHRs) while other MAC entities are not configured with the twoPHRmode.

At operation 510, the UE determines that the serving cell is configured with a multi-panel scheme and a second MAC entity to which the serving cell belongs to is configured with the mode—e.g., the second MAC entity is capable of twoPHRmode.

At operation 515, the UE determines if a first transmit control indicator (TCI) state is applied for a real PUSCH transmission at a slot where a PHR MAC control element (CE) is transmitted.

At operation 520, the UE can obtain a configured maximum transmission power (e.g., (P_{CMAX}) associated with the first TCI state when the first TCI state is applied for the real PUSCH transmission. That is, if the first TCI-State or TCI-UL-State is applied for a real PUSCH transmission at a slot where the PHR MAC CE is transmitted, the UE can obtain the value for the P_{CMAX,f,c} field for the PUSCH transmission associated to the first TCI-State or TCI-UL-State from the physical layer. In some embodiments, the UE can further determine if a maximum permissible exposure (MPE) report procedure for a frequency range two (e.g., FR2) is configured for the MAC entity and if this serving cell operates on the frequency range two. In such embodiments, if the MPE report parameter is configured, the UE can obtain a value for a MPE associated with the first TCI state when the first TCI state is applied for the real PUSCH transmission.

At operation 525, the UE can transmit, to the serving cell, the PHR MAC CE based on obtaining the configured maximum transmission power associated with the first TCI state.

In some embodiments, the UE can obtain a configured maximum transmission power associated with a second TCI state when the second TCI state is applied for the real PUSCH transmission—e.g., or when the first TCI state is not applied for the real PUSCH transmission. That is, the UE can determine the transmission at the PHR MAC CE is the real PUSCH transmission associated with the second initial TCI state. In such embodiments, the UE can further determine the P_{CMAX} associated with the second initial TCI state based at least in part on determining the real transmission is associated with the second initial TCI state. That is, if the second TCI-State or TCI-UL-State is applied for the real PUSCH transmission at the slot where the PHR MAC CE is transmitted, the UE can obtain the value for the P_{CMAX,f,c} field for the PUSCH transmission associated to the second TCI-State or TCI-UL-State from the physical layer.

In some examples the UE can obtain the configured maximum transmission power associated with the first TCI state when there is no real PUSCH transmission at the slot where the PHR MAC CE is transmitted—e.g., when the signaling received during the slot where the PHR MAC CE is transmitted is not a real transmission. In such embodiments, the UE can determine the P_{CMAX} associated with the first initial TCI state based at least in part on determining the transmission is not a real PUSCH transmission. That is, when the serving cell is configured with multiplepanelScheme SDM or multipanelSchemeSFN, and there is no real transmission, the UE can obtain the value for the P_{CMAX,f,c} field for the PUSCH transmission associated to the first TCI-State or TCI-UL-State from the physical layer.

In some embodiments, the UE can further determine if a maximum permissible exposure (MPE) report procedure for a frequency range two (e.g., FR2) is configured for the MAC entity and if this serving cell operates on the frequency range two. In such embodiments, if the MPE report parameter is configured, the UE can obtain a value for a MPE associated with the second TCI state when the second TCI state is applied for the real PUSCH transmission. In at least one embodiment, the UE can obtain the value for the MPE associated with the first TCI state when there is no real PUSCH transmission at the slot where the PHR MAC CE is transmitted.

Various embodiments in the disclosure provides a mechanism for PHR where a reporting MAC entity is not configured in a two PHR mode (e.g., twoPHRMode).

Various embodiments in the disclosure provide a UE behavior when connecting to a MAC entity configured with two PHR and a serving cell is configured with multiple TRP PUSCH or a MAC entity is not configured with the two PHR. In such examples, the UE can provide PHR to the reporting MAC entity based on whether a real transmission is received.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a processor configured to:
determine that i) a first medium access control (MAC) entity is not configured with a mode providing two power headroom reports (PHRs) or ii) the first MAC entity is configured with the mode and a first serving cell to which the first MAC entity belongs is configured with multiple transmit and receipt point (TRP) physical uplink shared channel (PUSCH) repetition;
determine whether there is at least one real physical uplink shared channel (PUSCH) transmission at a slot where a PHR MAC control element (CE) is transmitted;
determine whether a first transmission control indicator (TCI) state is associated with the at least one real PUSCH transmission when there is the at least one real PUSCH transmission at the slot where the PHR MAC CE is transmitted; and
obtain a configured maximum transmission power associated with the first TCI state in a case that the first TCI state is associated with the at least one real PUSCH transmission; and
a transceiver operably coupled to the processor, the transceiver configured to:
transmit, via the first MAC entity, the PHR MAC CE based on at least the obtained configured maximum transmission power associated with the first TCI state.

2. The UE of claim 1, wherein the processor is further configured to:
obtain a configured maximum transmission power associated with a second TCI state in a case that the second TCI state is associated with the at least one real PUSCH transmission.

3. The UE of claim 1, wherein the processor is further configured to:
obtain a value of a type-1 power headroom of the least one real PUSCH transmission associated with the first TCI state, the type-1 power headroom indicating a difference between a UE maximum transmit power and an estimated power for the real PUSCH transmission in a case that the first TCI state is associated with the at least one real PUSCH transmission.

4. The UE of claim 1, wherein the processor is further configured to:
determine that the first TCI state is not associated with the at least one real PUSCH transmission when there is at least one real PUSCH transmission at the slot where the PHR MAC CE is transmitted; and
obtain a value of the type-1 power headroom of the at least one real PUSCH transmission associated with a second TCI state in a case that the first TCI state is not associated with the at least one real PUSCH transmission.

5. The UE of claim 1, wherein the processor is further configured to:
obtain a value of the type-1power headroom of a reference PUSCH transmission associated with the first TCI state when there is not at least one real PUSCH transmission at the slot where the PHR MAC CE is transmitted.

6. The UE of claim 5, wherein the processor is further configured to:
obtain a configured maximum transmission power for the reference PUSCH transmission associated with the first TCI state when there is not at least one real PUSCH transmission at the slot where the PHR MAC CE is transmitted.

7. The UE of claim 1, wherein the processor is further configured to:
determine that a second serving cell is configured with a multi-panel scheme.

8. The UE of claim 7, wherein the multi-panel scheme is a multi-panel scheme spatial division multiplexing (SDM) or a multi-panel scheme single frequency network (SFN).

9. The UE of claim 1, wherein the processor is further configured to:
determine that a second MAC entity to which a second serving cell belongs is configured with the mode providing two PHRs.

10. The UE of claim 1, wherein the processor is further configured to:
determine that a second serving cell is configured with a multi-panel scheme and a second MAC entity to which the second serving cell belongs is configured with the mode.

11. The UE of claim 1, wherein the processor is further configured to:
determine that a maximum permissible exposure (MPE) report procedure for a frequency range two (FR2) is configured for the MAC entity and if a second serving cell operates on the frequency range two; and
obtain a value for a MPE associated with the first TCI state when the first TCI state is applied for the real PUSCH transmission.

12. The UE of claim 11, wherein the processor is further configured to:
obtain a value for a MPE associated with a second TCI state when the second TCI state is applied for the real PUSCH transmission.

13. The UE of claim 11, wherein the processor is further configured to:
obtain the value for the MPE associated with the first TCI state when there is no real PUSCH transmission at the slot where the PHR MAC CE is transmitted.

14. A method performed by a user equipment (UE) for facilitating communication in a wireless network, comprising:
determining that i) a first medium access control (MAC) entity is not configured with a mode providing two power headroom reports (PHRs) or ii) the first MAC entity is configured with the mode and a first serving cell to which the first MAC entity belongs is configured with multiple transmit and receipt point (TRP) physical uplink shared channel (PUSCH) repetition;
determining whether there is at least one real physical uplink shared channel (PUSCH) transmission at a slot where a PHR MAC control element (CE) is transmitted;
determining whether a first transmission control indicator (TCI) state is associated with the at least one real PUSCH transmission when there is the at least one real PUSCH transmission at the slot where the PHR MAC CE is transmitted;
obtaining a configured maximum transmission power associated with the first TCI state in a case that the first TCI state is associated with the at least one real PUSCH transmission; and
transmitting, via the first MAC entity, the PHR MAC CE based on at least the obtained configured maximum transmission power associated with the first TCI state.

15. The method of claim 14, further comprising:
obtaining a configured maximum transmission power associated with a second TCI state in a case that the second TCI state is associated with the at least one real PUSCH transmission.

16. The method of claim 14, further comprising:
obtaining a value of a type-1 power headroom of the least one real PUSCH transmission associated with the first TCI state, the type-1 power headroom indicating a difference between a UE maximum transmit power and an estimated power for the real PUSCH transmission in a case that the first TCI state is associated with the at least one real PUSCH transmission.

17. The method of claim 14, further comprising:
determining that the first TCI state is not associated with the at least one real PUSCH transmission when there is at least one real PUSCH transmission at the slot where the PHR MAC CE is transmitted; and
obtaining a value of the type-1 power headroom of the at least one real PUSCH transmission associated with a second TCI state in a case that the first TCI state is not associated with the at least one real PUSCH transmission.

18. The method of claim 14, further comprising:
obtaining a value of the type-1 power headroom of a reference PUSCH transmission associated with the first TCI state when there is not at least one real PUSCH transmission at the slot where the PHR MAC CE is transmitted.

19. The method of claim 18, further comprising:
obtaining a configured maximum transmission power for the reference PUSCH transmission associated with the first TCI state when there is no real PUSCH transmission at the slot where the PHR MAC CE is transmitted.

20. The method of claim 14, further comprising:
determining that a second serving cell is configured with a multi-panel scheme and a second MAC entity to which the second serving cell belongs is configured with the mode.
